(19) United States
(12) Patent Application Publication
(10) Pub. No.: US 2023/0264729 A1
(43) Pub. Date: Aug. 24, 2023

(54) Trash Can Holder

(71) Applicant: Rodger Thomas, Numa, IA (US)

(72) Inventor: Rodger Thomas, Numa, IA (US)

(21) Appl. No.: 18/170,677

(22) Filed: Feb. 17, 2023

Related U.S. Application Data
(60) Provisional application No. 63/312,616, filed on Feb. 22, 2022.

(51) Int. Cl. B62B 1/22; B62B 1/00; B62B 1/26

(52) U.S. Cl. CPC B62B 1/22; B62B 1/008; B62B 1/26; B62B 2202/20; B62B 2301/04

(57) ABSTRACT

The present invention is a trash can holder. The trash can holder is preferably sized to hold two forty-gallon trash cans, thereby preventing the trash cans from tipping-over due to wind or animals. In addition, the trash can holder has wheels that allows the user to move it, and the two trash cans, from one location to another by gasping the handle on the front side member of the device, raising the front end slightly, and pulling on it. Finally, the trash can holder includes a leg portion on the front side member that prevents any rolling movement of the trash can holder when the user is not lifting upward on the handle.

### CROSS-REFERENCE TO RELATED APPLICATION

The present application claims priority to, and the benefit of, U.S. Provisional Application No. 63/312,616, which was filed on February 22^{nd}, 2022, and is incorporated herein by reference in its entirety.

### FIELD OF THE INVENTION

The present invention relates generally to the field of refuse containers. More specifically, the present invention relates to a trash can holder that may be used in a residential area whereby the user needs to place one or more trash cans by the road for weekly trash removal. The trash can holder is preferably sized to hold two forty-gallon trash cans, thereby preventing the trash cans from tipping-over due to wind or animals. In addition, the trash can holder has wheels that allows the user to move it along with the two trash cans, from one location to another by gasping the handle on the front side member of the device, raising the front end slightly, and pulling on it. Finally, the device includes a leg portion on the front side member that prevents any rolling movement of the trash can holder when the user is not lifting upward on the handle. Accordingly, the present disclosure makes specific reference thereto. Nonetheless, it is to be appreciated that aspects of the present invention are also equally applicable to other like applications, devices, and methods of manufacture.

### BACKGROUND

By way of background, traditional trash cans that are used for residential purposes have approximately a forty-gallon capacity for storing trash and other debris. Due to their slender height to width ratio, said trash cans tend to tip over easily. Wind and animals seeking food can also cause a trash can to tip over. To make matters worse, a trash can that is typically stored near the garage or inside the garage must be placed next to the roadside curb on the day of or evening before trash removal service. This is when a trash can is particularly susceptible to tipping over due to wind or animals since it is unsupported by any other structure such as the garage wall. In addition, a forty-gallon capacity trash can may be heavy and difficult to move from the garage to the roadside curb.

Therefore, there exists a long-felt need in the art for a trash can holder that can support at least one forty-gallon trash can, thereby preventing the can from tipping over due to wind or animals. In addition, there is a long-felt need for a trash can holder that can keep the trash can and lid from blowing away due to strong wind. Finally, there is a long-felt need for a trash can holder that can be rolled from one location to another thereby allowing the user to move a trash can from a garage to the roadside curb without having to lift or drag the trash can.

The subject matter disclosed and claimed herein, is a trash can holder that includes a top-open, box-like structure preferably sized to hold two forty-gallon, typically plastic, trash cans. In addition, the trash can holder includes at least one wheel located on the back side of the device. The wheel, along with a handle located on the front side of the device, allows the trash can holder to be moved (or rolled) from one location to another. The user simply gasps the handle, lifts upward on the handle so that the leg used for keeping the device stationary is now spaced a distance away from the ground, and then pulls on the handle to move the device. Once the trash can holder has been moved along with the two secured trash cans, the user can then lower the front end of the device down again. The leg, which is located on the front side of the trash can holder prevents rolling motion of the device when it is contacting the ground.

The front side member and back side member are spaced apart by a pair of lower, middle, and upper side members that are located on each side of the device. The separate side members allow for easy cleaning of the box-like, internal storage area. Further, the two trash cans may be removed from the trash can holder by lifting each of them vertically upward and out of the device to facilitate cleaning of the device and each trash can.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash can holder including a top-loading, internal storage area that is formed by a front side member, back side member, a bottom member, a pair of lower side support members, a pair of middle side support members, and a pair of upper side support members. Each of the lower, middle, and upper side support members are preferably 0.5 inch thick, 2.5 inches in width, and 48 inches in length made from wood, plastic, or other composite materials. The front side member and back side member are also preferably made from wood, plastic, or other composite materials, having a preferable height of 40 inches and a width of 15 inches. The bottom member is also preferably made from wood, plastic, or other composite materials, having a preferable thickness of 0.5 inches, length of 48 inches and a width of 15 inches.

The actual dimensions of the trash can holder may be adjusted to accommodate different sizes of trash cans. In addition, while it is preferable that the trash can holder to hold two trash cans, the overall dimensions of the device can be modified so that the device can hold one, or possibly more than two trash cans. The front side member, back side member, bottom member, and the side support members can be joined together by any traditional means such as screws, nails, adhesive, or the like.

Additional features of the trash can holder include a pair of wheels located on the back side of the device and a handle located on the front side of the device. Each wheel, preferably made from rubber, hard plastic, or other similar material, has a pivotal attachment to a respective lower side support member that will allow a rolling motion of the device in a frontward/rearward direction in any position about the pivotal attachment. The handle, preferable made from metal, wood, plastic, or other composite material, is affixed to the front side member using screws, nails, adhesive, or the like. The front side member includes a leg portion that is located on its lower end. When the trash can holder is in a stationary position, the leg portion is in contact with the ground, thereby preventing any rolling motion of the wheels.

When the user decides to place one or more trash cans into the internal storage area, the user simply elevates the trash can high enough so that they can place the trash can down into the internal storage area of the device. The box-like internal storage area of the trash can holder will support each of the trash cans, thereby preventing them from tipping over. Since the sides of the trash can holder are open, the user can remove any debris that may have fallen down between the trash can exterior and the internal storage area of the device. The trash can holder is preferably sized so that it is tall enough to support the trash cans, but not too tall that the trash can lid cannot be removed, while the trash can is placed into the internal storage area of the device.

When the user decides to move the trash can holder, the user simply grasps the handle with their hand, lifts upward on the handle so that the leg used for keeping the device stationary is spaced a distance away from the ground, and then pulls on the handle to move the device. Once the trash can holder has been moved along with the two secured trash cans, the user can then lower the front end of the device down again. The leg, which is located on the front side of the trash can holder, prevents rolling motion of the device when it contacts the ground.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a preferred embodiment of the trash can holder of the present invention as per the disclosed design;

FIG. 2 illustrates a perspective view of the embodiment of the present invention shown in FIG. 1 as per the disclosed design now with two trash cans inserted into the internal storage area;

FIG. 3 illustrates a perspective view of the embodiment of the present invention shown in FIG. 2 as per the disclosed design now being moved from one location to another by a user.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a trash can holder that can support two forty-gallon trash cans thereby preventing them from falling over due to wind or animals. In addition, there is a long-felt need for a trash can holder that can keep the two trash cans and their lids from blowing away due to strong wind. Finally, there is a long-felt need for a trash can holder that can be rolled from one location to another thereby allowing the user to move the trash cans from the garage to the roadside curb without having to lift or drag the individual trash cans.

The present invention is a trash can holder that includes a top-open, box-like structure preferably sized to hold two forty-gallon, typically plastic, trash cans. In addition, the trash can holder includes a pair of wheels located on the back side of the device. The wheels, along with a handle located on the front side of the device, allows the trash can holder to be moved (or rolled) from one location to another. The user simply grasps the handle, lifts upward on the handle so that the leg used for keeping the device stationary is spaced a distance away from the ground, and then pulls on the handle to move the device. Once the trash can holder has been moved along with the two secured trash cans, the user can then lower the front end of the device down again. The leg, which is located on the front side of the trash can holder prevents the rolling motion of the device when it contacts the ground.

The front side member and back side member are spaced apart by a pair of lower, middle, and upper side members that are located on each side of the device. The separate side members allow for easy cleaning of the box-like, internal storage area. Further, the two trash cans may be removed from the trash can holder by lifting each of them vertically upward and out of the device to facilitate cleaning of the device and each trash can.

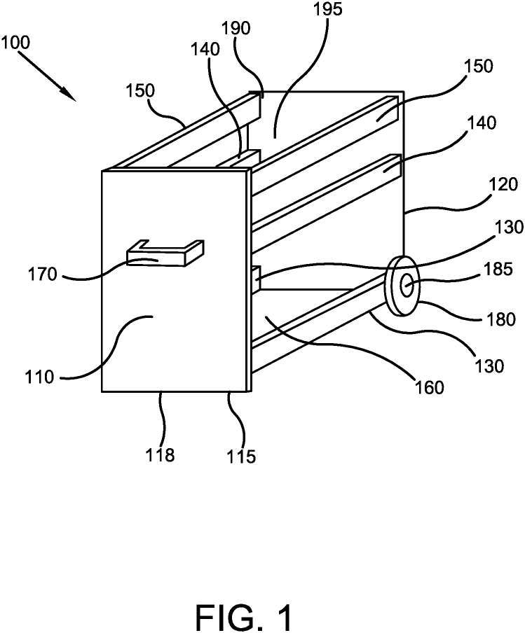

Referring initially to the drawings, FIG. 1 illustrates a perspective view of a preferred embodiment of the trash can holder 100 of the present invention as per the disclosed design. The trash can holder 100 includes a top opening 190 to an internal storage area 195 that is formed by a front side member 110, back side member 120, a bottom member 160, a pair of lower side support members 130, a pair of middle side support members 140, and a pair of upper side support members 150. Each of the lower 130, middle 140, and upper 150 side support members are preferably 0.5 inch thick, 2.5 inches in width, and 48 inches in length made from wood, plastic, or other composite material. The front side member 110 and back side member 120 are also preferably made from wood, plastic, or other composite material, having a preferable height of 40 inches and a width of 15 inches. The bottom member 160 is also preferably made from wood, plastic, or other composite material, having a preferable thickness of 0.5 inches, length of 48 inches and a width of 15 inches.

The actual dimensions of the trash can holder 100 may be adjusted to accommodate different sizes of trash cans 200. In addition, while it is preferable to size the trash can holder 100 to hold two trash cans 200, the overall dimensions of the trash can holder 100 can be modified so that it can hold at least one, or possibly more two or more trash cans 200. The front side member 110, back side member 120, bottom member 160, and the side support members (130, 140, 150) can be joined together by any traditional means such as screws, nails, adhesive, or the like.

Additional features of the trash can holder 100 include at least one wheel 180 located on the back side of the trash can holder 100 and a handle 170 located on the front side of the device 100. Each wheel 180, preferably made from rubber, hard plastic, or other similar material, has a pivotal attachment 185 to a respective lower side support member 130 that will allow a rolling motion of the device 100 in a frontward/rearward direction. In one embodiment, the attachment 185 allows each wheel 180 to rotate within a 360-degree range of motion. The handle 170, preferably made from metal, wood, plastic, or other composite material, is affixed to the front side member 110 using screws, nails, adhesive, or the like. The front side member 110 includes a leg portion 115 that is located on its lower end 118. When the trash can holder 100 is in a stationary position, the leg portion 115 is in contact with the ground, thereby preventing any rolling motion of the wheels 180 (i.e., the holder 100 must be lifted upwards using the handle 170 to be moved).

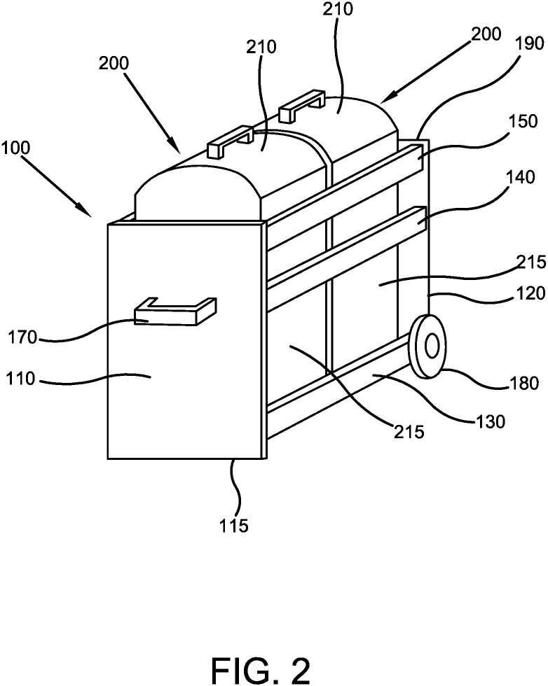

FIG. 2 illustrates a perspective view of the embodiment of the present invention shown in FIG. 1 as per the disclosed design now with two trash cans 200 inserted into the internal storage area 195. When the user 300 decides to place one or more trash cans 200 into the internal storage area 195, the user 300 simply elevates the trash can 200 high enough so that they can place the trash can 200 down into the internal storage area 195 of the device 100. The box-like internal storage area 195 of the trash can holder 100 will support each of the trash cans 200 thereby preventing them from tipping over. Since the sides of the trash can holder 100 are open, the user 300 can remove any debris that may have fallen down between the trash can exterior 215 and the internal storage area 195 of the device 100. The trash can holder 100 is preferably sized so that it is tall enough to support the trash cans 200, but not too tall that the trash can lid 210 cannot be removed while the trash can 200 is placed into the internal storage area 195 of the device 100.

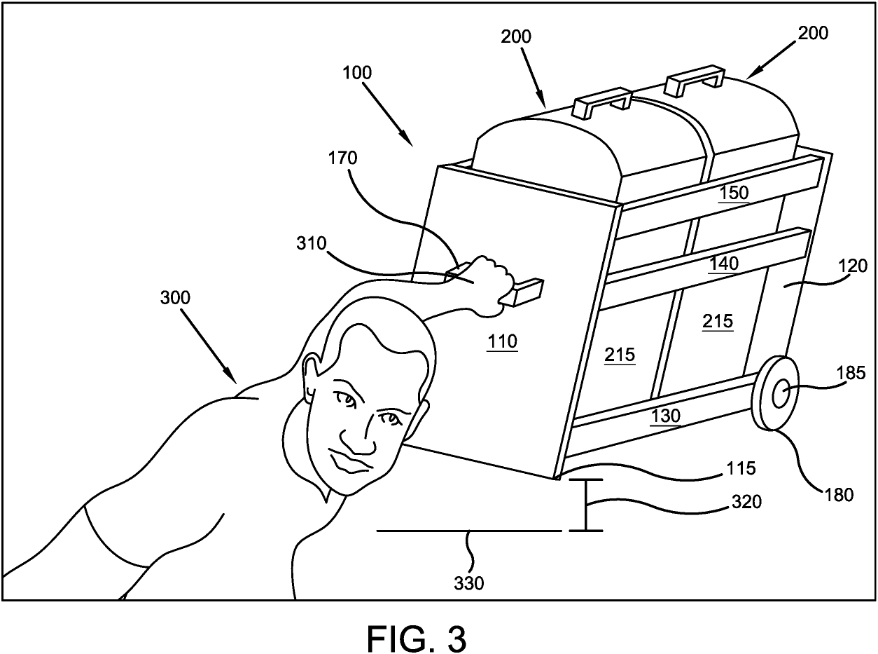

FIG. 3 illustrates a perspective view of the embodiment of the present invention shown in FIG. 2 as per the disclosed design now being moved from one location to another by a user 300. When the user 300 decides to move the trash can holder 100, the user 300 simply gasps the handle 170 with their hand 310, lifts upward on the handle 170 so that the leg 115 used for keeping the device stationary is spaced a distance 320 away from the ground 330, and then pulls on the handle 170 to move the device 100. Once the trash can holder 100 has been moved along with the two secured trash cans 200, the user 300 can then lower the front end of the device 100 down again. The leg 115, which is located on the front side 110 of the trash can holder 100 prevents rolling motion of the device 100 when it contacts the ground 330.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trash can holder” and “device” are interchangeable and refer to the trash can holder 100 of the present invention.

Notwithstanding the foregoing, the trash can holder 100 of the present invention can be of any suitable size and configuration as is known in the art without affecting the overall concept of the invention, provided that it accomplishes the above-stated objectives. One of ordinary skill in the art will appreciate that the size, configuration, and material of each of the trash can holder 100 as shown in the FIGS. are for illustrative purposes only, and that many other sizes and designs of the trash can holder 100 are well within the scope of the present disclosure. Although the dimensions of each of the trash can holder 100 are important design parameters for user convenience, the trash can holder 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash can holder comprised of:
a handle;
a front side member;
a lower side support member;
a wheel; and
an internal storage area.

2. The trash can holder of claim 1, wherein the wheel is comprised of a rubber material.

3. The trash can holder of claim 1, wherein the internal storage area is a rectangular shape.

4. The trash can holder of claim 1, wherein the handle is positioned on the front side member.

5. A trash can holder comprised of:
a front side member;
a handle positioned on the front side member;
a middle side support member;
a bottom member;
a lower side support member
a wheel positioned on the lower side support member; and
an internal storage area.

6. The trash can holder of claim 5, wherein the handle is comprised of a metal, a wood or a plastic material.

7. The trash can holder of claim 5, wherein the wheel attaches to the lower side support member via a pivotal attachment.

8. The trash can holder of claim 7, wherein the pivotal attachment allows the wheel to rotate in at least three directions.

9. The trash can holder of claim 7, wherein the pivotal attachment allows the wheel to rotate 360 degrees relative to the pivotal attachment.

10. A trash can holder comprised of:
a front side member comprised of a handle and a leg portion;
a first middle side support member;
a second middle support member;
a first upper side support member;
a second upper side support member;
a bottom member;
a back side member;
a first lower side support member comprised of a first wheel;
a second lower side support member comprised of a second wheel; and
an internal storage area.

11. The trash can holder of claim 10, wherein the front side member, the middle side support member, the upper side support member, and the back side member are positioned to form a top opening.

12. The trash can holder of claim 11, wherein the bottom member and the top opening are substantially parallel to one another.

13. The trash can holder of claim 10, wherein the leg portion inhibits the movement of the wheel when the trash can holder is stationary.

14. The trash can holder of claim 10, wherein the front side member is attached to the backside member via the upper side support member, the middle side support member, and the lower side support member.

15. The trash can holder of claim 10, wherein the leg portion is positioned below the lower side support member.

16. The trash can holder of claim 10, wherein the first middle side support member and the second middle side support member are substantially parallel to one another.

17. The trash can holder of claim 10, wherein the first upper side support member and the second upper side support member are substantially parallel to one another.

18. The trash can holder of claim 10, wherein the first lower side support member and the second lower side support member are substantially parallel to one another.

19. The trash can holder of claim 10, wherein the front side member and the back side member are substantially parallel to one another.

20. The trash can holder of claim 10, wherein the first wheel and the second wheel are substantially parallel to one another.
